(19) United States
(12) Patent Application Publication
(10) Pub. No.: US 2014/0204083 A1
(43) Pub. Date: Jul. 24, 2014

(54) SYSTEMS AND METHODS FOR REAL-TIME DISTORTION PROCESSING

(71) Applicant: Brent Thomson, Mapleton, UT (US)

(72) Inventor: Brent Thomson, Mapleton, UT (US)

(21) Appl. No.: 14/162,021

(22) Filed: Jan. 23, 2014

Related U.S. Application Data
(60) Provisional application No. 61/755,834, filed on Jan. 23, 2013.

(51) Int. Cl. G06T 17/00

(52) U.S. Cl. CPC G06T 17/00
USPC 345/420

(57) ABSTRACT

Image data may be processed using graphics processing resources of a computing device. The processing may comprise resolving distortion in the image data using the graphics processing resources, which may comprise determining a distortion compensation model corresponding to the image data, and configuring the graphics processing resources to transform the image data in accordance with the distortion compensation model. The distortion compensation model may be based on characteristics of the image data and/or image capture device used to acquire the image data, such as geometric distortions introduced by wide-angle lens components, and the like. The distortion compensation model may be further configured to model distortions introduced by an irregular projection surface. Input image data may be transformed in accordance with the distortion compensation model for projection onto the irregular projection surface.

### TECHNICAL FIELD

This disclosure relates to systems and methods for image and video processing and, in particular, to processing image data in response to geometric and/or non-geometric image distortion present in the image data.

### BRIEF DESCRIPTION OF THE DRAWINGS

Non-limiting and non-exhaustive embodiments of the disclosure are described, including various embodiments of the disclosure with reference to the figures, in which:

FIG. 1 is a block diagram of one embodiment of a system for distortion processing;

FIG. 2 is a block diagram of another embodiment of a system for distortion processing;

FIG. 3 depicts one embodiment of image data comprising a region of interest;

FIG. 4 is a flow diagram of one embodiment of a method for distortion processing;

FIG. 5 is a flow diagram of another embodiment of a method for distortion processing;

FIG. 6 is a block diagram of another embodiment of a system for distortion processing;

FIG. 7 is a block diagram of another embodiment of a system for distortion processing; and

FIG. 8 is a flow diagram of another embodiment of a method for distortion processing;

In the following description, numerous specific details are provided for a thorough understanding of the various embodiments disclosed herein. However, those skilled in the art will recognize that the systems and methods disclosed herein can be practiced without one or more of the specific details, or with other methods, components, materials, etc. In addition, in some cases, well-known structures, materials, or operations may not be shown or described in detail in order to avoid obscuring aspects of the disclosure. Furthermore, the described features, structures, or characteristics may be combined in any suitable manner in one or more alternative embodiments.

### DETAILED DESCRIPTION

Many computing devices include graphics processing resources. As used herein, graphics processing resources may include, but are not limited to: dedicated graphics processing units (GPUs), peripheral components, integrated graphics processing resources (e.g., one or more GPUs and/or graphics processing cores integrated into a general-purpose processor), or the like. Accordingly, the graphics processing resources may comprise dedicated hardware and/or hardware components of the computing device. Alternatively, or in addition, graphics processing resources may comprise software components, such as interfaces to graphics processing resources, graphics processing libraries, and so on.

Graphics processing resources are typically used to render graphical content for display to a user. Rendering graphical content may comprise loading a three-dimensional model of a scene, rendering a view of the scene from a particular vantage point (e.g., camera position), applying texture data to objects within the scene, and/or rasterizing the scene (e.g., converting the three-dimensional model into a two-dimensional image for display on a display device).

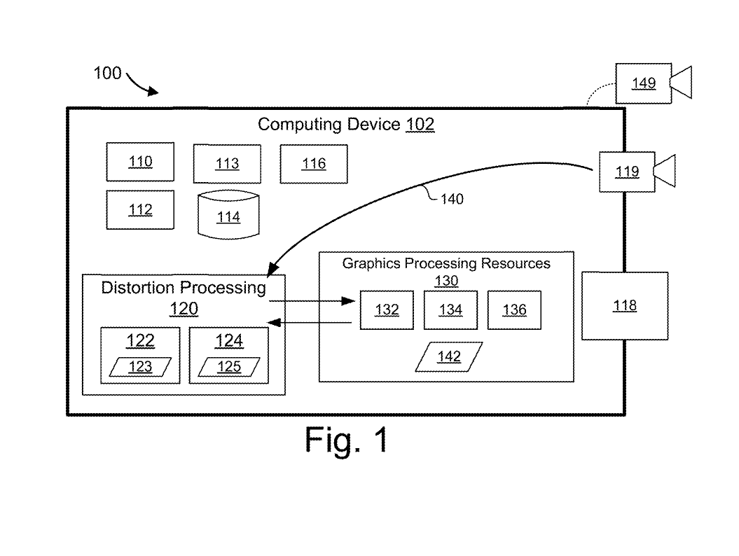

In some embodiments, however, graphics processing resources may be leveraged to perform other functions. FIG. 1 depicts one embodiment a system 100 for distortion processing. The system 100 comprises a computing device 102. The computing device 102 may be any device capable of performing computing tasks, and may include, but is not limited to: a personal computing device (e.g., desktop computer, a set-top box, media player, projector, etc.); portable computing device (e.g., laptop, notebook, netbook, tablet, etc.); mobile computing device (e.g., personal digital assistant, personal media device, etc.); communication device (e.g., smart phone, telephone, Internet Protocol (IP) phone, video phone, etc.); embedded computing device (e.g., vehicle control system, entertainment system, display device, projector, etc.); or the like. The computing device 102 may comprise general-purpose processing resources 110 (e.g., one or more central processing units (CPUs), processing cores, or the like), volatile memory 112, one or more communication interfaces 113 (e.g., one or more network interfaces), non-volatile storage 114, input/output devices 116, and so on.

The system 100 may further comprise distortion processing module 120. The distortion processing module 120 may be embodied as one or more hardware modules and/or components, which may include, but are not limited to: integrated circuits, chips, packages, die, peripheral components, expansion cards, or the like. Alternatively, or in addition, the distortion processing module 120 may be embodied as machine-readable instructions configured to be executed by use of the processing resources 110 of the computing device 102 (e.g., executed by a general purpose processor of the computing device and/or graphical processing resources of the computing device). The instructions may be stored on a machine-readable storage medium, such as the non-volatile storage 114

The distortion processing module 120 may be configured to process image data by use of the graphics processing resources 130 of the computing device 102. The image data may be processed in order to, inter alia, compensate for distortion in the image data, select a region of interest within distorted image data, project image data onto a distorted surface, or the like. As used herein, “image data” may include, but is not limited to: still images (e.g., individual images and/or files), video data, or the like. As used herein, image “distortion” and/or “distorted image data” refers to image data in which the shape and/or configuration of one or more objects represented within the image data are altered or modified in some way. In some cases, image distortion may be introduced by optical components of an image capture device (e.g., a camera). For instance, image data captured by use of certain types of lenses, such as wide angle or fish eye lenses may result in image distortion.

In some embodiments, the distortion processing module 120 is configured to process distorted image data by use of the graphics processing resources 130 of the computing device 102. As used herein, distortion compensation includes, but is not limited to: addressing geometrical distortions within image data, selecting a region of interest within image data comprising geometric distortions, introducing geometric distortions into image data, or the like. The graphics processing resources 130 of the computing device 102 may include, but are not limited to: one or more GPUs 132, graphics processing memory and/or storage resources 134, graphics processing I/O resources 136 (e.g., one or more buses for use in transferring data to and/or from the graphics processing resources), and the like. The graphics processing resources 130 may be configured to render and/or display graphical content on one or more display resources 118 of the computing device 102. The display resources 118 may comprise one or more external display devices, such as external monitors, projectors, or the like. The display resources 118 may be communicatively coupled to the computing device 102 via a video display interface, such as a Video Graphics Array (VGA) cable, Digital Visual Interface (DVI) cable, High-Definition Media Interface (HDMI) cable, or the like. Alternatively, or in addition, the display resources 118 may comprise one or more integrated display interfaces.

The distortion processing module 120 may be configured to leverage the graphics processing resources 130 to perform real-time distortion processing operations on the input image data 140. The input image data 140 may comprise still image data, video data, or the like. In some embodiments, the input image data 140 is captured by use of an image capture module 119 of the computing device 102. The image capture module 119 may comprise a camera, an interface to an external image capture device 149, or the like. Alternatively, or in addition, the input image data 140 may be acquired from the memory 112, non-volatile storage 114, and/or communication interface 113 of the computing device 102.

The distortion processing module 120 may be configured to determine a distortion model 123 corresponding to distortion (if any) within the input image data 140 and to process the input image data 140 by use of the graphics processing resources 130 of the computing device 102. The distortion processing module 120 may be further configured to make the processed image data 142 available for, inter alia, display on one or more display(s) 118 of the computing device 102.

The distortion processing module 120 may comprise a distortion modeling module 122 configured to determine a distortion model 123 corresponding to distortion within the input image data 140. As disclosed above, distortion may be introduced into image data by the device(s) used to capture the image data, such as wide angle lenses, filters, capture media, and/or the like. In some embodiments, the distortion modeling module 122 is configured to determine the distortion model 123 by querying the image capture device 119 and/or 149 to determine the lens and/or image capture settings used to acquire the input image data 140. Alternatively, or in addition, the distortion modeling module 122 may be configured to determine the distortion model 123 by use of the input image data 140 itself. In some embodiments, for example, the input image data 140 may comprise image capture settings (e.g., lens properties and/or settings) as metadata within the input image data 140 (e.g., as Exchangeable Image File Format (EXIF) data). The distortion modeling module 122 may be configured to determine the distortion model in other ways. For example, the distortion modeling module 122 may be configured to calculate a distortion model of the input image data 140 using image processing techniques and/or based upon user-configurable settings and/or properties.

In some embodiments, the distortion modeling module 122 determines the distortion model 123 of the input image data 140 in a one-time operation (e.g., at initialization time). Alternatively, the distortion model module 122 may be configured to continually update the distortion model in response to changes to the distortion within the input image data 140 (e.g., in response to changes in the lens and/or image capture settings used by the image capture device 119 and/or 149 to acquire the input image data 140). For example, the input image data 140 may have been captured by an image capture device having an adjustable lens, such that portions of the image data are captured with first image capture settings (e.g., a first focal length) and other portions of the image data are captured with second, different image capture settings (e.g., a second, different focal length). The distortion processing module 122 may be configured to update the distortion model 123 used to process the input image data 140 (e.g., generate first and second distortion models 123) to model the different types of distortion in different portions of the input image data 140. The distortion modeling module 122 may be further configured to generate a distortion model 123 pertaining to a particular region of interest within the input image data 140 and/or pertaining to particular objects within the input image data 140.

The distortion processing module 120 may further comprise a distortion compensation module 124 configured to generate a distortion compensation model 125 in response to the distortion model 123. The distortion compensation model 125 may be configured to model the “inverse” of the distortion within the input image data 140. Accordingly, the distortion compensation module 124 may be configured to generate a distortion compensation model 125 that is the geometric inverse of the distortion within the input image data 140 (e.g., the inverse of the distortion model 123).

The distortion processing module 120 may be configured to process the input image data using the distortion compensation model 125, which may comprise using the graphics processing resources 130 of the computing device to project the input image data 140 onto the distortion compensation model 125 and to render the resulting projection.

The distortion compensation module 124 may be configured to generate the distortion compensation model 125 in a format configured for use by the graphics processing resources 130. Accordingly, the distortion compensation module 124 may be configured to generate the distortion compensation model 125 in a format that emulates and/or is compatible with models of rendered graphical content (e.g., models for procedural content typically rendered by the graphics processing resources 130). In some embodiments, the distortion compensation module 124 is configured to generate the distortion compensation model 125 as an array of triangles defined in three-dimensional space, wherein each triangle is defined by three points (x, y, and z). The triangles of the distortion compensation model 125 may form a three-dimensional mesh such that the triangles each touch three or more other triangles along their respective vertices to approximate the inverse of the distortion model 123 of the input image data 140.

The distortion processing module 120 may configure the graphics processing resources 130 to transform the input image data 140 in accordance with the distortion compensation model 125. In some embodiments, transforming the input image data 140 comprises projecting the input image data 140 onto the distortion compensation model 125. Accordingly, transforming the input image data 140 may further comprise generating output image data 142, which may comprise rasterizing the projection of the input image data 140 onto the three-dimensional distortion compensation model 125 into a two-dimensional, output image data 142. The distortion processing module 120 may configure the graphics processing resources 130 to stream the output image data 142 to one or more displays 118, to the memory 112, the communication interface 113, and/or non-volatile storage 114, or the like.

The distortion processing module 120 may be configured to provide the distortion compensation model 125 to the graphics processing resources 130. As disclosed above, the distortion compensation model 125 may be provided in a format that is compatible with the graphics processing resources 130 (e.g., as an array of triangles, or in another suitable format). The distortion processing module 120 may provide the distortion compensation model 125 to the graphics processing resources 130 by use of dedicated graphics I/O resources 136, such as a dedicated graphics bus, shared memory, Direct Memory Interface (DMI), or the like. The distortion compensation model 125 may be stored in graphics memory and/or storage resources 134.

The distortion processing module 120 may be further configured to provide the input image data 140 to the graphics processing resources 130. The distortion processing module 120 may be configured to stream the input image data 140 to a graphics texture buffer (storage and/or memory resources 134) by use of graphics I/O resources 136, such as a dedicated graphics bus, shared memory, DMI, or the like, as disclosed above. The distortion processing module 120 may configure the graphics processing resources 130 to project the input image data 140 within the texture buffer onto the distortion compensation model 125, which may comprise the graphics processing resources 130 using the contents of the texture buffer (the input image data 140) to color the triangles in the distortion compensation model 125 while applying corresponding transformations consistent with the three-dimensional surface defined by the distortion compensation model 125. The projected image data may form output image data 142. The output image data 142 may be streamed to one or more displays 118, to memory 112 storage, to the communication interface 113, and/or non-volatile storage 114, as disclosed above.

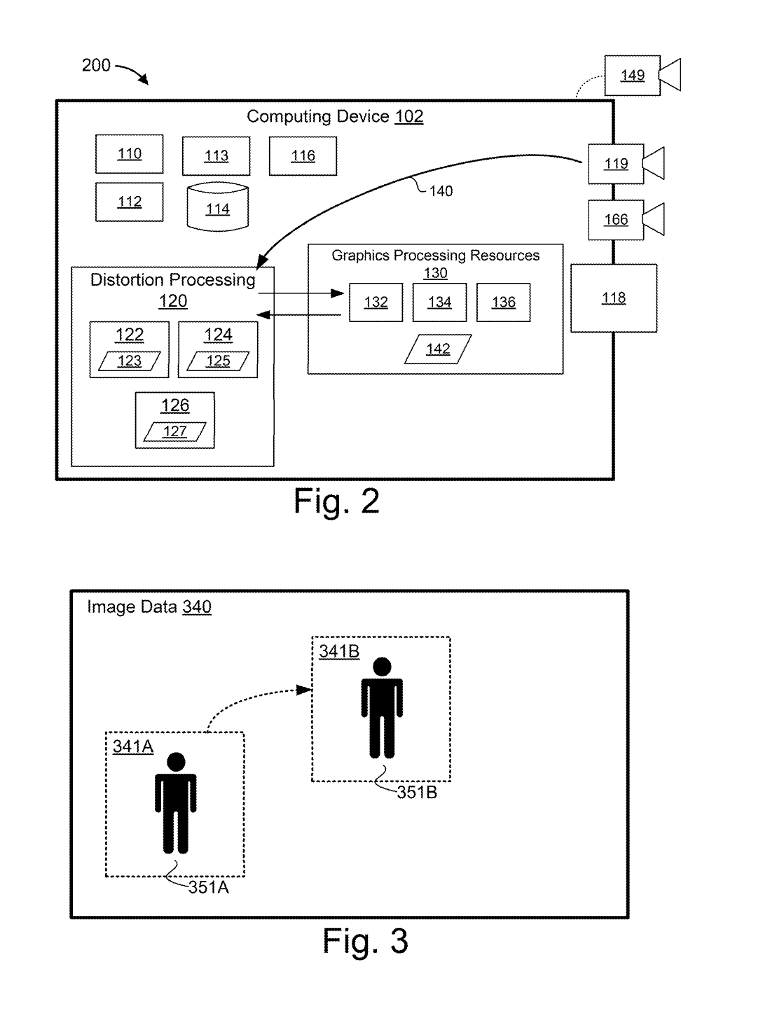

FIG. 2 is a block diagram of another embodiment of a system 200 for distortion processing. In the FIG. 2 embodiment, the distortion processing module 120 may further comprise a region-of-interest (ROI) module 126. The ROI module may be configured to determine a region of interest within the input image data 140. As used herein, a region of interest (ROI) refers to a sub-region of image data (e.g., a portion or region within image data). Referring to FIG. 3, image data 340 may cover a relatively large area, only a portion of which may be of interest. For example, the image data 340 may correspond to a video conference; the image data 340 may capture a large meeting area, but only the portion(s) that include the participant are of interest. As depicted in FIG. 3, regions of interest within the image data 340 may be dynamic. For example, participants may be seated at different positions and/or may move within the capture area of the image data 340. The region of interest 341A may capture the participant in a first position 351A, and the region of interest 341B may capture the caller in a second position 351B. Moreover, the region of interest may dynamically change as the participant moves from portion 351A to 351B.

Referring back to FIG. 2, the ROI module 126 may be configured to determine the region of interest within the input image data 140. The ROI module 126 may be further configured to determine a crop space 127 (e.g., a visible area and/or viewport) based on the determined region of interest. The crop space 127 may be provided to the graphics processing resources 130, such that only the region of interest defined by the crop space 127 is output in the output image data 142. The crop space 127 may be provided in a format that is compatible with the graphics processing resources 130. In some embodiments, the crop space 127 may be defined in terms of rendering camera settings (e.g., picture plane, focal point, etc.).

The ROI module 126 may be configured to determine the region of interest within the image data 140 using any suitable technique. In some embodiments, the input image data 140 may be captured in real-time. For example, the input image data 140 may correspond to an ongoing video conference. The input image data 140 may be captured by use of a wide-angle lens configured to capture large area. However, only the portion that includes the caller may be of interest. The ROI module 126 may be configured to dynamically determine the region of interest (the region comprising the caller) and thus may update the region of interest based on movement of the caller. The ROI module 126 may detect the location of the caller by use of image processing techniques (e.g., pattern recognition, facial recognition, etc.). Alternatively, or in addition, the ROI module 126 may detect the region of interest by use of one or more sensors 166. The sensors 166 may include, but are not limited to: electro-optical capture devices (e.g., infra-red capture device), stereoscopic cameras, audio sensors, microphones, or the like. The ROI module 126 may be further configured to determine a depth of the region of interest within the scene corresponding to the image data 140 by use of the sensors 166. Accordingly, as used herein, a region of interest may refer to a) a region within a two-dimensional image (e.g., x and y coordinates) and/or b) a depth of one or more objects captured within the region of interest (e.g., z coordinate). In some embodiments, a focal location of the region of interest (e.g., the depth of the subject matter) may be determined using the sensors 166, which may include a depth sensor, such as an electro-optical depth sensor, an ultrasonic distance sensor, stereoscopic cameras, a passive autofocus sensor, or the like.

In some embodiments, the ROI module 126 may be configured to determine the region of interest within the image data 140 based on an infra-red signature of one or more persons within the image data 140. Accordingly, determining the region of interest may comprise correlating the image data 140 with one or more sensor devices 166 such that information acquired by the sensor devices 166 can be correlated to regions within the image data 140. For example, the ROI module 126 may be configured to correlate infra-red imaging data acquired by one or more of the sensors 166 with image data 140 to determine the location of a person within the image data 140. Alternatively, or in addition, the ROI module 126 may be configured to detect the region of interest based on audio information (e.g., using audio source position detection). The sensors 166 may comprise one or more audio sensors configured to detect audio signals generated within the scene captured by the image data 340. The sensors 166 may be further configured to determine the location of the source of the audio signals by, inter alia, triangulating audio signals acquired from one or more audio sensors 166.

As disclosed above, the ROI module 126 may be configured to determine the depth of one or more object(s) within the determined region of interest (e.g., the region of interest may correspond to a x, y, z position of one or more objects with respect to the image capture device 119). The ROI module 126 may be configured to determine the depth of the object(s) based on, inter alia, a configuration of the image capture device 119, by use of one or more of the sensors 166 (e.g., a dedicated range sensor), by triangulating data acquired by one or more of the sensors 166, and/or the like. In some embodiments, the ROI module 126 is configured to a) determine a region of interest with respect to the two-dimensional scene corresponding to the image data (e.g., x and y coordinates), and b) determine the depth of the object(s) within the determined region of interest using one or more dedicated range sensors 166. The ROI module 126 may, for example, be configured to determine the location of a person within the image by use of an infra-red sensor 166, and determine the z-position of the person relative to the image capture device 119 using one or more other sensors 166 and/or dedicated range-finding sensors 166 (e.g., LIDAR, or the like).

As disclosed above, in some embodiments, the distortion modeling module 122 is configured to determine a distortion model 123 by use of one or more sensors 166. The sensors 166 may be used to a) determine a location of an object within the input image data 140 and/or b) determine a relative position of the object with respect to the image capture device 119 (e.g., an x, y, z position of the object).

The distortion modeling module 122 may be configured to actively determine the distortion model 123 by use of one or more of the sensors 166. In some embodiments, for example, the distortion modeling module 122 may configured one or more of the sensors 166 to transmit pattern data into a field of view of the image capture device 119. The pattern data may comprise, inter alia, a pre-determined grid pattern and/or the like. The sensors 166 may be configured to emit the pattern data using one or more of: visible EO radiation, non-visible EO radiation, and/or the like. The pattern data may be emitted intermittently (e.g., in short bursts), such that the pattern data does not interfere with and/or is not readily perceptible by persons within the field of view of the image capture device 119. Pattern data may be captured by the image capture device 119 for use by the distortion modeling module 122 to determine the distortion model 123 (e.g., compare the captured pattern data to the emitted pattern data).

The distortion processing module 120 may be configured to receive an indication of the region of interest from the ROI module 126. The indication of the region of interest may include a location in the picture plane and/or a focal location (e.g., a depth of subject matter). The distortion processing module 120 may generate the distortion model 123 for the region of interest. By generating the distortion model 123 only for the region of interest, less processing may be required. The distortion processing module 120 may generate the distortion model 123 based on the location of the region of interest in the picture plane and/or the focal location of the region of interest (e.g., the depth of the subject matter with respect to the image capture device 119). The distortion processing module 120 may provide the region of interest to the graphics processing resources 130 as well as a distortion compensation model corresponding to the region of interest and determined from the distortion model 123 to correct the distortion.

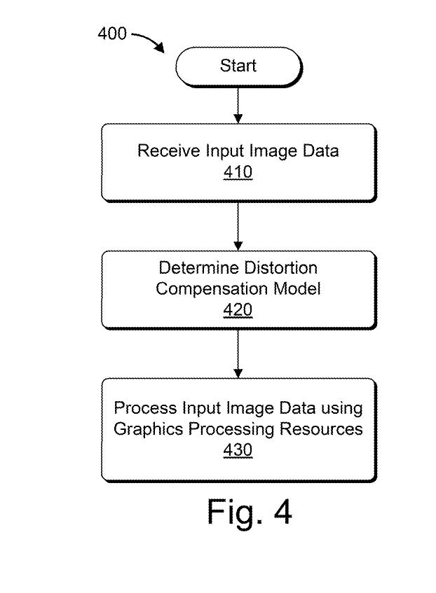

FIG. 4 is a flow diagram of one embodiment of a method 400 for distortion processing. The method 400, and the other methods disclosed herein, may be embodied as machine-readable instructions on a storage medium, such as the non-volatile storage 114. The instructions may be configured to cause a computing device to perform one or more steps of the disclosed methods.

Step 410 may comprise receiving input image data 140. The input image data 140 may be received directly from an image capture device 119 and/or 149. Alternatively, the input image data 140 may be received via a communication interface 113 (e.g., network), memory 112, non-volatile storage 114, or the like.

Step 420 may comprise determining a distortion compensation model 125 corresponding to distortion within the input image data 140. The distortion compensation model 125 may correspond to an inverse and/or compliment of distortion(s) within the input image data 140. In some embodiments, the distortion compensation model 125 may be generated in response to a distortion model 123 determined by a distortion modeling module 122. Alternatively, the distortion compensation model 125 may be determined directly from the input image data 140 itself.

Step 430 may comprise processing the input image data 140 by use of graphics processing resources 130 of a computing device 102. The processing of step 430 may comprise transforming the input image data in accordance with the distortion compensation model 125. Step 430 may, therefore, comprise providing the distortion compensation model 125 to the graphics processing resources 130 and streaming the input image data 140 to the graphics processing resources 130. Step 430 may further comprise configuring the graphics processing resources 130 to project the input image data 140 onto the distortion compensation model 125 (e.g., apply the input image data 140 as texture data to the distortion compensation model 125). Accordingly, step 430 may further comprise decoding the input image data 140 and streaming the input image data 140 to a texture buffer of the graphics processing resources 130.

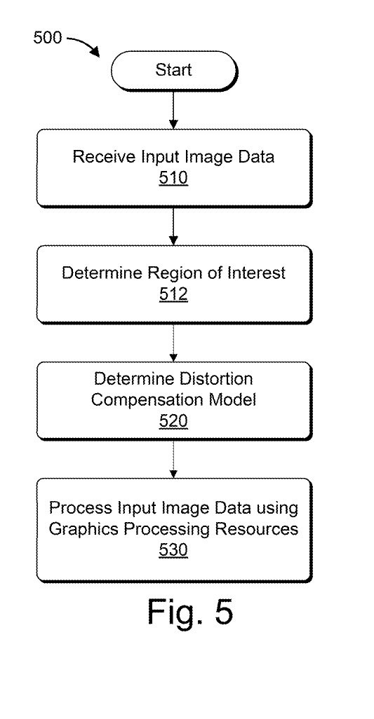

FIG. 5 is a flow diagram of another embodiment of a method 500 for distortion processing. Step 510 may comprise receiving input image data 140, as disclosed above.

Step 512 may comprise determining a region of interest within the input image data 140. As disclosed above, the region of interest may correspond to a portion (e.g., sub-region) of the input image data 140. The region of interest may correspond to a particular person and/or object within the input image data 140. In some embodiments, the region of interest is determined by use of data acquired by one or more sensor devices 166. Accordingly, step 166 may comprise correlating data by use of the sensor devices 166 to the input image data 160, and determining the region of interest based upon the correlated sensor data. Step 512 may further comprise utilizing one or more of the sensors 166 to determine a depth of object(s) within the determined region of interest relative to the image capture device 119, as disclosed above. Accordingly, the region of interest determined at step 512 may indicate the x, y, and/or z position of the one or more objects relative to the image capture device.

Step 520 may comprise determining a distortion compensation model 125, as disclosed above. In some embodiments, step 520 comprises determining a distortion compensation model pertaining to the determined region of interest (as opposed to modeling the distortion within the entire image). In some embodiments, the distortion modeling of step 520 may incorporate the depth of one or more objects within the region of interest with respect to the image capture device 119. As disclosed above, the depth of the one or more objects may determine, inter alia, the type and/or extent of distortion introduced by the image capture device 119. For example, an object positioned closer to the image capture device 119 may be distorted in a different manner and/or extent than an object positioned farther away from the image capture device 119.

Step 530 comprises processing the input image data by use of the graphics processing resources 130, as disclosed above. Step 530 may further comprise providing the region of interest to the graphics processing resources 130 and/or configuring the graphics processing resources 130 to render only a portion of the input image data 140 (e.g., define a crop area 127 within the input image data 140).

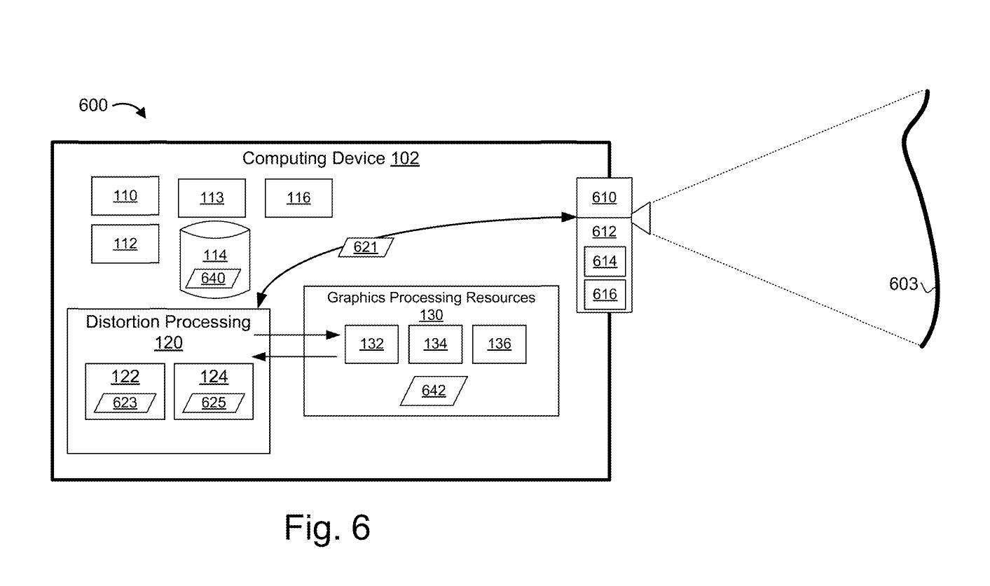

The systems and methods disclosed herein may be configured to perform distortion processing for image output operations. FIG. 6 depicts one embodiment of a system 600 configured to provide for processing image data for display. The computing device 102 may comprise and/or be communicatively coupled to an image output device 610, such as a projector. The projector 610 may be configured to provide for displaying input image data 640 (e.g., project the input image data 640 onto a surface, such as a uniform projection screen, not shown).

In some embodiments, the system 600 may comprise projection surface 603. The projection surface 603 may be non-uniform and/or may comprise irregularities, such as bumps, ridges, waves, and so on. Accordingly, un-processed input image data 640 projected onto the projection surface 603 may appear to be distorted (due to the irregularities in the surface).

The distortion processing module 120 may be configured to process the input image data 640 to compensate for irregularities of the projection surface 603 by use of the graphics processing resources 130 of the computing device 102, as described herein. The distortion processing module 120 may be configured to acquire the input image data 640 from a computer-readable storage medium 114 (as depicted in FIG. 6), from a communication interface 113, from an image capture device 119 (not shown in FIG. 6), or the like.

The distortion modeling module 122 may be configured to determine a distortion model 623 of the projection surface 603. In some embodiments, determining the distortion model 623 may comprise manually configuring the distortion modeling module 122 with information pertaining to the projection surface 603. The configuration information may comprise information pertaining to the irregularities, such as the shape and/or model of the projection surface 603. Alternatively, or in addition, the distortion modeling module 122 may be configured to acquire distortion modeling data 621 pertaining to the projection surface 603. The distortion modeling data 621 may comprise any information pertaining to characteristics of the projection surface 603.

The distortion modeling data 621 may comprise image data obtained from the projection surface 603. In some embodiments, the distortion processing module 122 comprises and/or is communicatively coupled to a pattern imaging module 612. The pattern imaging module 612 may be configured to project pattern image data onto the projection surface 603 and to detect the image pattern as projected thereon. Accordingly, the pattern imaging module 612 may comprise a pattern projection module 614 and pattern sensor module 616. In some embodiments, the pattern projection module 614 is separate from the projector 610 (e.g., comprises a separate image projector). Alternatively, the pattern imaging module 612 may leverage the existing image projector 610 to project pattern data. The pattern data may comprise a grid image, or any suitable image for detecting distortions in a projected image. The pattern sensor module 616 may be configured to detect the image projected onto the projection surface 603 by the pattern projector module 614. Accordingly, the pattern sensor module 616 may comprise an image sensor, such the image capture module 119, disclosed above and/or a separate image capture device.

The distortion modeling module 122 may configure the pattern imaging module 612 to project pattern image data onto the projection surface 603 (by use of the pattern projection module 614) and to acquire distortion modeling data 621 therefrom (e.g., distorted pattern image data captured by the pattern image sensor 616). The distortion modeling module 122 may compare the original pattern image data to distorted image data to determine a distortion model 623. The distortion model 623 may comprise a three-dimensional model of the distortion(s) (if any) introduced by the projection surface 603.

The distortion compensation module 124 may be configured to generate a distortion compensation model 625 corresponding to the distortion model 623. As disclosed above, the distortion compensation model 625 may comprise an inverse and/or complement of the distortion model 623. The distortion compensation model 124 may be further configured to generate the distortion compensation model 625 in a format that emulates and/or is compatible with models of rendered graphical content (e.g., a mesh of triangles, or the like).

The distortion processing module 120 may configure the graphics processing resources 130 to transform the input image data 640 in accordance with the distortion compensation model 625. In some embodiments, transforming the input image data 640 comprises projecting the input image data 640 into the distortion compensation model 625 (by use of the graphics processing resources). Accordingly, transforming the input image data 640 may comprise projecting the input image data 640 onto a three-dimensional structure defined by the distortion compensation model 625 and rasterizing the result into two-dimensional output image data 642. As disclosed above, the distortion processing module 120 may configure the graphics processing resources 130 to stream the output image data 140 to the projector 610 for display on the projection surface 603 (or other output device).

In some embodiments, the distortion modeling module 122 is configured to determine the distortion model 623 of the projection surface 603 at startup and/or initialization time. Such embodiments may be used where the projection surface 603 is static (e.g., the side of a building, or the like). In some embodiments, however, the distortions introduced by the projection surface 603 may be dynamic. For example, the projection surface 603 may comprise fabric that changes its shape and/or configuration in response to wind or other disturbances. The distortion modeling module 122 may be configured to periodically update the distortion model 623 in response to such changes, resulting in corresponding updates to the distortion compensation model 625. The distortion modeling module 122 may perform such updates during operation (e.g., while the output image data 642 is being projected onto the projection surface 603). In some embodiments, the distortion modeling module 122 may configure the pattern imaging module 612 to continuously and/or periodically provide updated distortion modeling data 621, which may comprise continuously and/or periodically projecting pattern image data onto the projection surface 603 and detecting the pattern image data projected thereon. The pattern projection module 614 may be configured such that the image pattern data does not affect projection of the output image data 642. Accordingly, the pattern projection module 614 may be configured to project pattern image data in a non-visible spectrum, such as infra-red, ultra-violet, or other non-visible portion(s) of the electro-optical radiation spectrum. The pattern sensor module 616 may be configured to capture image data in accordance with the configuration of the pattern projection module 614.

In an embodiment, the pattern projection module 614 may be configured to interleave the pattern image data with the output image data 642. The pattern image data may be interleaved without affecting projection of output image data 642 (e.g., without affecting timing of projection of the output image data). For example, the pattern image data may be displayed between frames of the output image data 642. The timing of projection of the pattern image data may be selected to prevent perception by a viewer. The pattern image data may be projected for shorter than an expected perception threshold of a viewer (e.g., less than 1/120, 1/100, 1/60, 1/50, 1/30, or 1/25 of a second or the like). Additionally, several frames of output image data 642 may be displayed between frames of pattern image data to prevent the repetitive display of the pattern image data from causing perception (e.g., the time between projection of each frame of the pattern image data may be longer than 0.1, 0.25, 0.5, 1, or 2 seconds or the like). A same projector or distinct projectors may be used to display the output image data 642 and the interleaved pattern image data. The pattern imaging module 612 may control timing of display of the interleaved pattern image data for distinct projectors. The distortion compensation model 625 may be dynamically updated based on distortion detected in the projected pattern image data each time a frame of pattern image data is displayed. Alternatively, or in addition, the pattern projection module 614 may be configured to modify a polarity, intensity, and/or wavelength of the pattern image data, such that the pattern image data is not perceptible. The pattern projection module 614 disclosed herein may be incorporated into the embodiments of FIGS. 1 and/or 2 for use in modeling distortion in captured image data 140, as disclosed above.

The distortion compensation module 124 may be configured to update the distortion compensation model 625 in response to continuous and/or periodic changes to the distortion model 623. The distortion compensation module 124 may be further configured to provide the updates to the distortion compensation model 625 to the graphics processing resources 130 for use in generating the output image data 642 as disclosed herein.

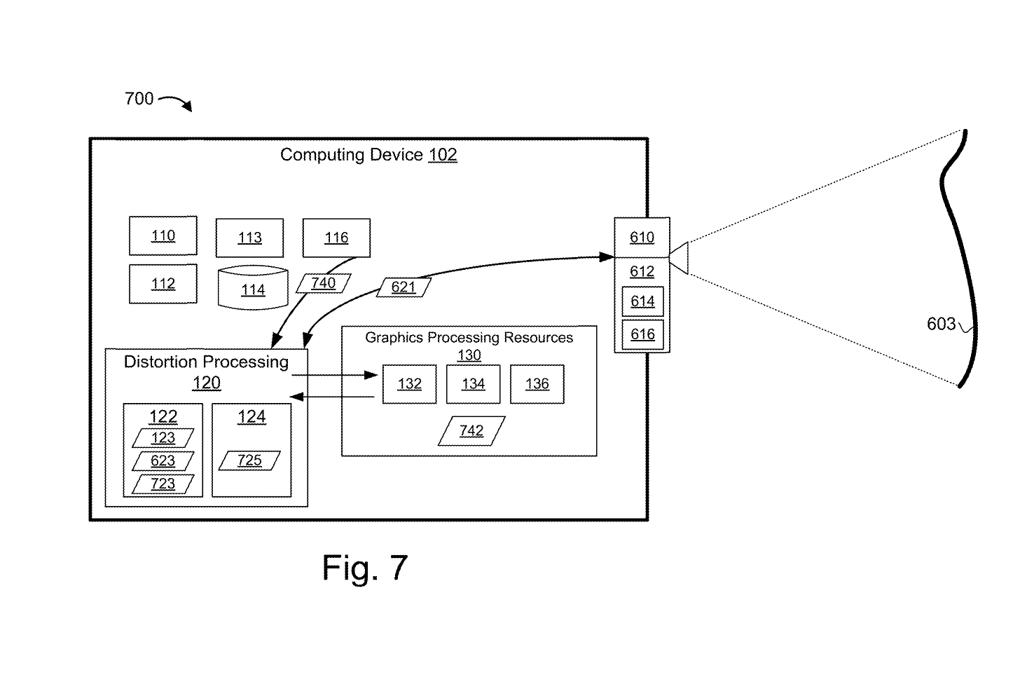

FIG. 7 depicts one embodiment of a system 700 comprising a distortion processing module 120 configured to perform distortion processing in response to distortions within the input image data 140 as well as distortion processing in response to an projection surface 603. The distortion modeling module 122 may be configured to determine a model 123 of the distortion(s) within input image data 740, which, as disclosed above, may comprise acquiring information pertaining to the image capture device (not shown) used to acquire the input image data 740, extracting information from the input image data 740, processing the image input data 740, or the like, as disclosed above. The distortion modeling module 122 may be further configured to determine a distortion model 623 corresponding to the projection surface 603, which, as disclosed above, may comprise configuring the distortion modeling module 122 and/or acquiring distortion modeling information 621 by use of the pattern imaging module 612. The distortion modeling module 122 may be further configured to generate a composite distortion model 723. The composite distortion model 723 may comprise a combination of the distortion model 123 and the distortion model 623. The composite distortion model 723 may be formed by, inter alia, three-dimensional addition and/or transformation operations. The distortion modeling module 122 and/or distortion compensation module 124 may be configured to continuously and/or periodically update the composite distortion model 723 and/or distortion compensation model 725 in response to changes in the input image data 740 and/or projection surface 603, as disclosed herein.

The distortion compensation module 124 may be configured to generate a distortion compensation model 725 based on the composite distortion model 723, as disclosed herein (e.g., as the inverse and/or complement of the composite distortion model 723). The distortion processing module 120 may configure the graphics processing resources 130 to transform the input image data 740 in accordance with the distortion compensation model 725 to generate output image data 742, as disclosed herein.

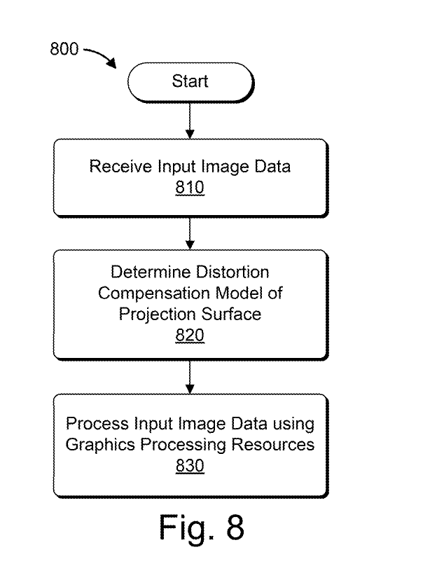

FIG. 8 is a flow diagram of one embodiment of a method 800 for distortion processing. The method 800 may start and be initialized as disclosed herein. Step 810 may comprise receiving input image data 740. Step 820 may comprise determining a distortion model of an projection surface 603. As disclosed herein, step 820 may comprise accessing and/or receiving configuration information pertaining to the projection surface 603. Alternatively, or in addition, step 820 may comprise acquiring distortion modeling information 621 pertaining to the projection surface 603 by use of the pattern imaging module 612. Step 820 may comprise determining the distortion compensation model continuously and/or periodically in response to changes to the projection surface 603. In some embodiments, step 820 may further comprise determining a composite distortion model 723 based on the distortion model 623 of the projection surface 603 and a distortion model 123 corresponding to the input image data 740.

Step 820 may further comprise determining a distortion compensation model 725 based on the distortion model 623 of the projection surface 603 and/or a composite distortion model 725, as disclosed above.

Step 830 may comprise processing the input image data 740 in accordance with the distortion compensation model 725 and by use of graphics processing resources 130 of the computing device 102, as disclosed herein. Step 830 may further comprise streaming processed, output image data 742 to an output device, such as the projector 610.

Reference throughout this specification to features, advantages, or similar language does not imply that all of the features and advantages that may be realized are included any single embodiment. Rather, language referring to the features and advantages is understood to mean that a specific feature, advantage, or characteristic described in connection with an embodiment is included in at least one embodiment. Thus, discussion of the features and advantages, and similar language, throughout this specification may, but do not necessarily, refer to the same embodiment.

The embodiments disclosed herein may involve a number of functions to be performed by a computer processor, such as a microprocessor. The microprocessor may be a specialized or dedicated microprocessor that is configured to perform particular tasks according to the disclosed embodiments, by executing machine-readable software code that defines the particular tasks of the embodiment. The microprocessor may also be configured to operate and communicate with other devices such as direct memory access modules, memory storage devices, Internet-related hardware, and other devices that relate to the transmission of data in accordance with various embodiments. The software code may be configured using software formats such as Java, C++, XML (Extensible Mark-up Language) and other languages that may be used to define functions that relate to operations of devices required to carry out the functional operations related to various embodiments. The code may be written in different forms and styles, many of which are known to those skilled in the art. Different code formats, code configurations, styles and forms of software programs and other means of configuring code to define the operations of a microprocessor in accordance with the disclosed embodiments.

Within the different types of devices, such as laptop or desktop computers, hand held devices with processors or processing logic, and also possibly computer servers or other devices that utilize the embodiments disclosed herein, there exist different types of memory devices for storing and retrieving information while performing functions according to one or more disclosed embodiments. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to various embodiments when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured disclosed herein enable the physical transformation of these memory devices. Accordingly, the embodiments disclosed herein are directed to novel and useful systems and methods that, in one or more embodiments, are able to transform the memory device into a different state. The disclosure is not limited to any particular type of memory device, or any commonly used protocol for storing and retrieving information to and from these memory devices, respectively.

Embodiments of the systems and methods described herein facilitate the management of data input/output operations. Additionally, some embodiments may be used in conjunction with one or more conventional data management systems and methods, or conventional virtualized systems. For example, one embodiment may be used as an improvement of existing data management systems.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

I claim:

1. An apparatus for correcting distortion in captured images, the apparatus comprising:
a distortion processing module configured to:
receive captured image data, an indication of a region of interest in the captured image data, and an indication of a depth of subject matter in the region of interest,
generate a distortion model of the region of interest based at least in part on the depth of the subject matter, and
compute a distortion compensation model for the region of interest based on the distortion model; and
graphics processing resources configured to transform the region of interest of the captured image data based on the distortion compensation model.

2. The apparatus of claim 1, further comprising a display device configured to display the transformed region of interest.

3. The apparatus of claim 1, further comprising a region of interest module configured to determine the region of interest and provide the indication of the region of interest to the distortion processing module.

4. The apparatus of claim 2, wherein the region of interest module is configured to determine the region of interest based on a technique selected from the group consisting of facial recognition, pattern recognition, and audio source position detection.

5. The apparatus of claim 4, the region of interest module is configured to determine the region of interest by triangulating audio signals acquired by one or more audio sensors.

6. The apparatus of claim 2, wherein the region of interest module is configured to dynamically update the region of interest based on movement by the subject matter.

7. The apparatus of claim 2, wherein the region of interest module is configured to determine the region of interest by correlating sensor data from a sensor with the captured image data.

8. The apparatus of claim 7, wherein the region of interest module is configured to correlate the sensor data from the sensor with a model of the captured image data generated by the distortion processing module.

9. The apparatus of claim 1, further comprising a depth sensing module configured to determine the depth of the subject matter in the region of interest and provide the indication of the depth to the distortion processing module.

10. The apparatus of claim 9, wherein the depth sensing module comprises a depth sensor selected from the group consisting of an electro-optical depth sensor, an ultrasonic distance sensor, stereoscopic cameras, and a passive autofocus sensor.

11. The apparatus of claim 1, wherein the graphics processing resources are configured to transform the region of interest of the captured image data by projecting the region of interest onto the distortion compensation model.

12. The apparatus of claim 1, wherein the distortion processing module is further configured to determine a distortion model of a projection surface, and wherein the distortion processing module is configured to compute the distortion compensation model based on the distortion model of the region of interest and the distortion model of the projection surface.

13. The apparatus of claim 12, wherein the distortion processing module is further configured to compute a composite distortion model from the distortion model of the region of interest and the distortion model of the projection surface, and wherein the distortion processing module is configured to compute the distortion compensation model based on the composite distortion model.

14. A non-transitory computer readable storage medium comprising program code configured to cause a processor to perform a method of correcting distortion in captured images, the method comprising:
receiving captured image data, an indication of a region of interest in the captured image data, and an indication of a depth of subject matter in the region of interest;
generating a distortion model of the region of interest based at least in part on the depth of the subject matter;
computing a distortion compensation model for the region of interest based on the distortion model;
transforming the region of interest of the captured image data based on the distortion compensation model; and
displaying the transformed region of interest.

15. A non-transitory computer readable storage medium comprising program code configured to cause a processor to perform a method of correcting distortion arising from irregularities in a projection surface, the method comprising:
projecting pattern image data onto the projection surface;
detecting the projected pattern image data;
generating a distortion model of the projection surface based on the projected pattern image data;
computing a distortion compensation model based on the distortion model;
transforming output image data based on the distortion compensation model; and
projecting the transformed output image data onto the projection surface,
wherein the pattern image data is interleaved with the output image data, and wherein the distortion compensation model is dynamically updated based on the interleaved pattern image data.

16. The non-transitory computer readable storage medium of claim 15, wherein the pattern image data is projected using a non-visible portion of the electro-optical radiation spectrum.

17. The non-transitory computer readable storage medium of claim 15, wherein the pattern image data is interleaved without affecting projection of the output image data.

18. The non-transitory computer readable storage medium of claim 17, wherein the pattern image data is interleaved without affecting timing of projection of the output image data.

19. The non-transitory computer readable storage medium of claim 15, wherein the pattern image data is projected for shorter than an expected perception threshold of a viewer.

20. The non-transitory computer readable storage medium of claim 15, wherein a time between projection of each frame of the pattern image data is long enough to prevent perception by a viewer.

21. The non-transitory computer readable storage medium of claim 15, wherein the pattern image data and the output image data are projected by distinct projectors.
